(19) United States
(12) Patent Application Publication
(10) Pub. No.: US 2025/0386780 A1
(43) Pub. Date: Dec. 25, 2025

(54) IRRIGATION DEVICE FOR POT AND RELATED METHODS

(71) Applicant: THAYER INDUSTRIES, INC., DUNDEE, FL (US)

(72) Inventors: SAMUEL S. THAYER, DUNDEE, FL (US); TIMOTHY D. WERT, DUNDEE, FL (US); KENNETH H. ANGSTADT, DUNDEE, FL (US); DIANNE M. HALLIDAY, DUNDEE, FL (US); TIMOTHY S. GEIGER, DUNDEE, FL (US); KENNETH F. TROY, DUNDEE, FL (US)

(21) Appl. No.: 19/223,279

(22) Filed: May 30, 2025

Related U.S. Application Data
(60) Provisional application No. 63/661,716, filed on Jun. 19, 2024.

(51) Int. Cl. A01G 27/00

(52) U.S. Cl. CPC A01G 27/008

(57) ABSTRACT

An irrigation device includes an irrigation body having a first side and a second side opposite the first side, and a lower end between the first and second sides and having first and second vertical arms defining a slot. The lower end includes a lower lateral arm adjacent to the first side. The irrigation body includes an upper end above the lower end and between the first and second sides, the upper end having an upper lateral arm adjacent to the second side. The irrigation body includes a medial portion between the first and second sides and between the lower end and the upper end, the medial portion defining a lateral slot extending from the first side to the second side. The irrigation device includes a water hose extending through the lower lateral arm and the upper lateral arm, and a spray device.

### RELATED APPLICATION

This application is based upon prior filed copending Application No. 63/661,716 filed Jun. 19, 2024, the entire subject matter of which is incorporated herein by reference in its entirety.

### TECHNICAL FIELD

The present disclosure relates to the field of irrigation, and, more particularly, to pot irrigation devices and related methods.

### BACKGROUND

Irrigation systems for use in orchards have been designed whereby flow tubing is positioned along crops planted in rows and means are provided to divert flow via take-off tubing to individual plants or trees. In one approach, each plant is supplied with a stake that supports the take-off tubing, flow valve, and flow adapter to determine the flow pattern.

In some applications, irrigation must be directed to crops contained within pots. Here, tubing is positioned along a line of pots, and each pot has a take-off tube connected to a main line of tubing.

### SUMMARY

Generally, an irrigation device is to be attached to a pot. The irrigation device comprises an irrigation body comprising a first side and a second side opposite the first side, and a lower end between the first and second sides and comprising first and second vertical arms defining a slot therebetween to receive a wall of the pot. The lower end comprises a lower lateral arm adjacent to the first side. The irrigation body also includes an upper end above the lower end and between the first and second sides. The upper end comprises an upper lateral arm adjacent to the second side. The irrigation body further includes a medial portion between the first and second sides and between the lower end and the upper end. The medial portion defines a lateral slot extending from the first side to the second side. The irrigation device also includes a water hose having a proximal end extending through the lower lateral arm and a distal end extending through the upper lateral arm, and a spray device coupled to the distal end of the water hose adjacent the upper lateral arm.

Another aspect is directed to a method for making an irrigation device is to be attached to a pot. The method comprises forming an irrigation body comprising a first side and a second side opposite the first side, and a lower end between the first and second sides and comprising first and second vertical arms defining a slot therebetween to receive a wall of the pot. The lower end comprises a lower lateral arm adjacent to the first side. The irrigation body also includes an upper end above the lower end and between the first and second sides. The upper end comprises an upper lateral arm adjacent to the second side. The irrigation body further includes a medial portion between the first and second sides and between the lower end and the upper end. The medial portion defines a lateral slot extending from the first side to the second side. The method also includes coupling a water hose having a proximal end extending through the lower lateral arm and a distal end extending through the upper lateral arm, and coupling a spray device to the distal end of the water hose adjacent the upper lateral arm.

### BRIEF DESCRIPTION OF THE DRAWINGS

FIG. 1 is a perspective view of a first example embodiment of an irrigation device, according to the present disclosure.

FIGS. 2-3 are front and rear views, respectively, of the irrigation device from FIG. 1.

FIG. 4 is a perspective view of a second example embodiment of an irrigation device, according to the present disclosure.

FIG. 5 is a front view of the irrigation device from FIG. 4.

FIGS. 6-7 are side views of an irrigation body from the irrigation device from FIGS. 1-5.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

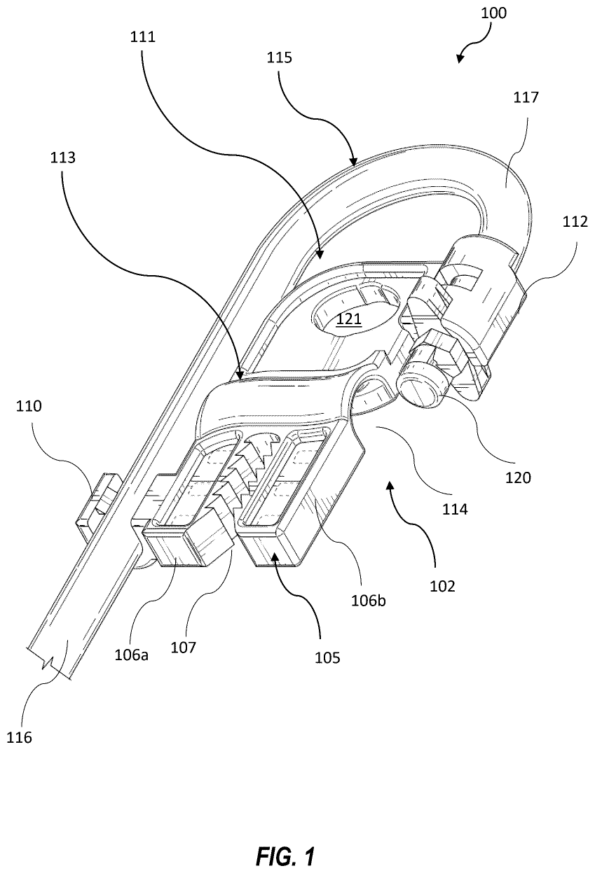

Referring initially to FIGS. 1-3 & 6-7, an irrigation device 100 according to the present disclosure is now described. The irrigation device 100 is to be attached to a pot 101. The irrigation device 100 comprises an irrigation body 102 comprising a first side 103 and a second side 104 opposite the first side. For example, the irrigation body 102 may comprise a plastic material, such as a polymer plastic. Other materials of sufficient mechanical strength may be used, for example, metallic materials.

The irrigation body 102 illustratively comprises a lower end 105 between the first and second sides 103, 104 and comprising first and second vertical arms 106a-106b defining a slot 107 therebetween to receive a wall of the pot 101. The lower end 105 illustratively includes a lower lateral arm 110 adjacent to the first side. The lower lateral arm 110 defines a U-shaped channel extending longitudinally.

The irrigation body 102 also includes an upper end 111 above the lower end 105 and between the first and second sides 103, 104. The upper end 111 includes an upper lateral arm 112 adjacent to the second side 104. The upper lateral arm 112 also defines a U-shaped channel.

The irrigation body 102 further includes a medial portion 113 between the first and second sides 103, 104 and between the lower end 105 and the upper end 111. The medial portion 113 defines a lateral slot 114 extending from the first side 103 to the second side 104. The irrigation device 100 also includes a water hose 115 having a proximal end 116 extending through the U-shaped channel of the lower lateral arm 110. The water hose 115 extends along the first side 103 of the irrigation body 102 and over the upper end 111. The water hose 115 illustratively includes a distal end 117 extending through the upper lateral arm 112. The irrigation device 100 also includes and a spray device 120 coupled to the distal end 117 of the water hose 115 below the upper lateral arm 112. In other words, this irrigation device 100 projects the water spray downward.

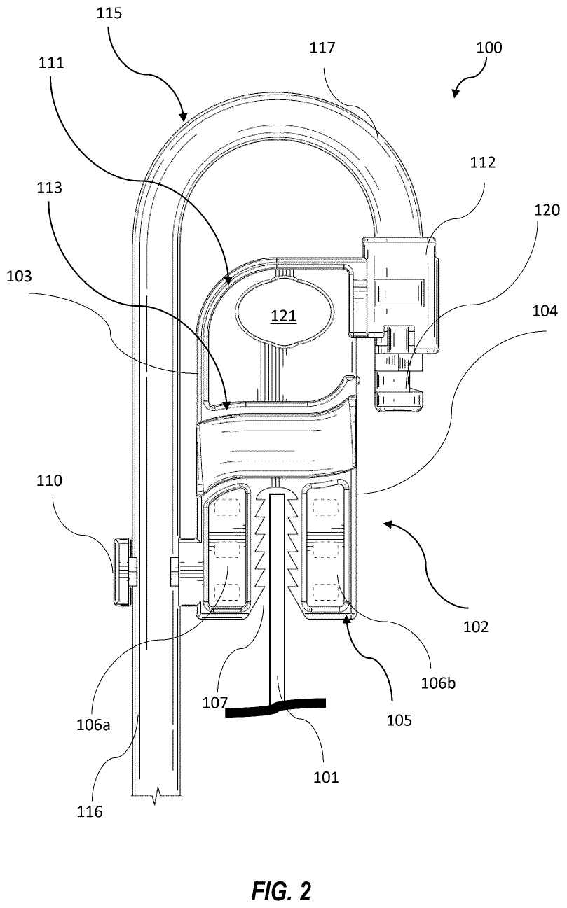

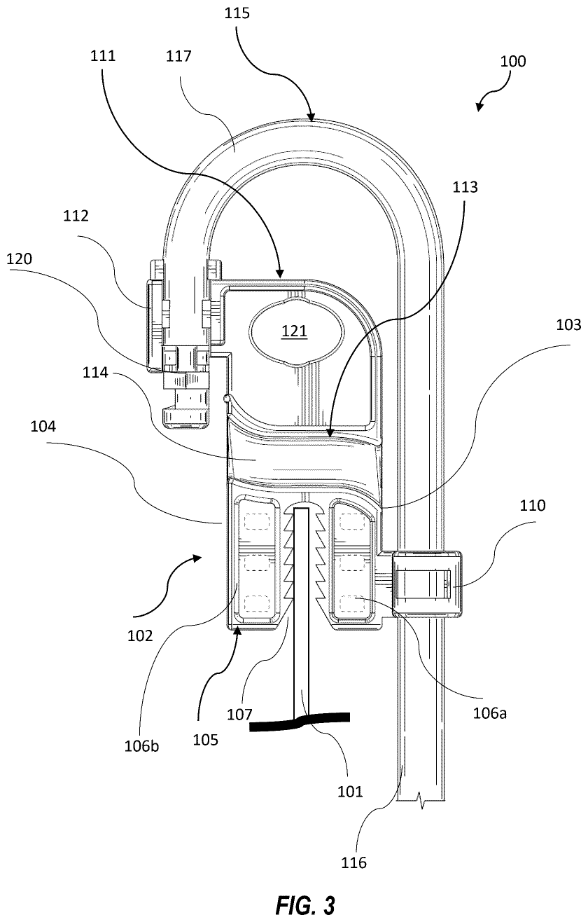

Further, the upper end 111 comprises an opening 121 aligned with the upper lateral arm 112. As will be appreciated, the opening 121 may be used to store and bind the water hose 115 in a closed state to prevent water flow therethrough. In particular, the water hose 115 would be folded, and the folded end would be inserted into the opening 121. Also, as perhaps best seen in FIGS. 2-3, the first and second vertical arms 106a-106b have jagged internal edges about the slot 107, which better retain the wall of the pot 101.

Another aspect is directed to a method for making an irrigation device 100 is to be attached to a pot 101. The method comprises forming an irrigation body 102 comprising a first side 103 and a second side 104 opposite the first side, and a lower end 105 between the first and second sides and comprising first and second vertical arms 106a-106b defining a slot 107 therebetween to receive a wall of the pot 101. The lower end 105 comprises a lower lateral arm 110 adjacent to the first side 103. The irrigation body 102 also includes an upper end 111 above the lower end 105 and between the first and second sides 103, 104. The upper end 111 comprises an upper lateral arm 112 adjacent to the second side 104. The irrigation body 102 further includes a medial portion 113 between the first and second sides 103, 104 and between the lower end 105 and the upper end 111. The medial portion 113 defines a lateral slot 114 extending from the first side 103 to the second side 104. The method also includes coupling a water hose 115 having a proximal end 116 extending through the lower lateral arm 110 and a distal end 117 extending through the upper lateral arm 112, and coupling a spray device 120 to the distal end of the water hose adjacent the upper lateral arm.

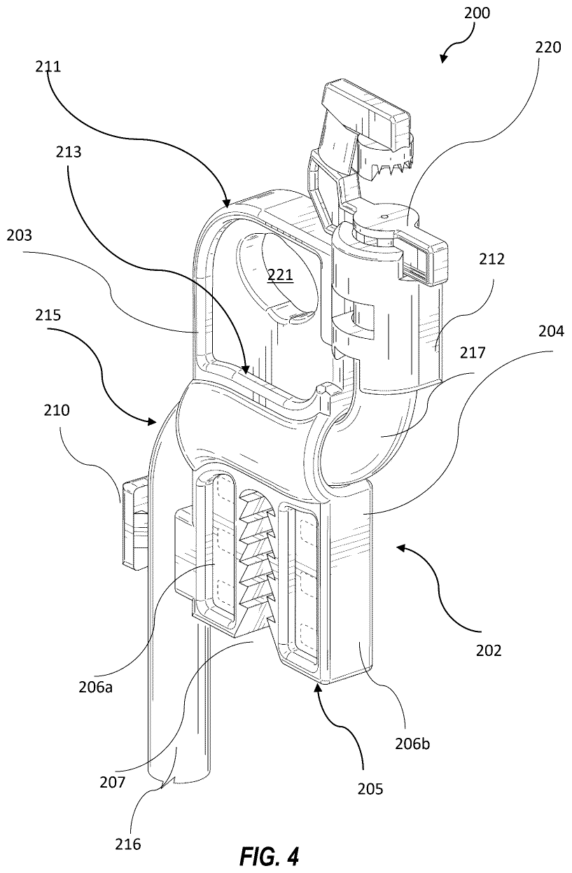

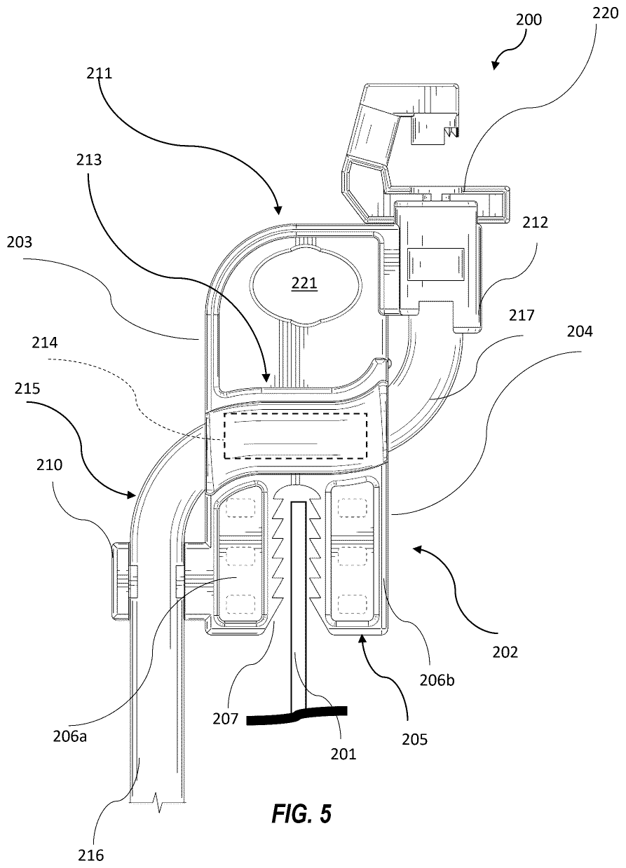

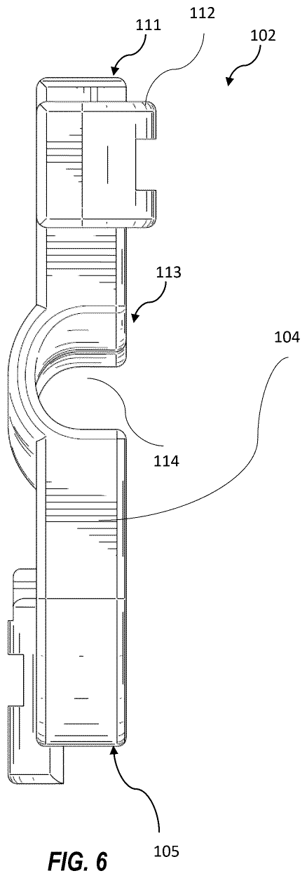

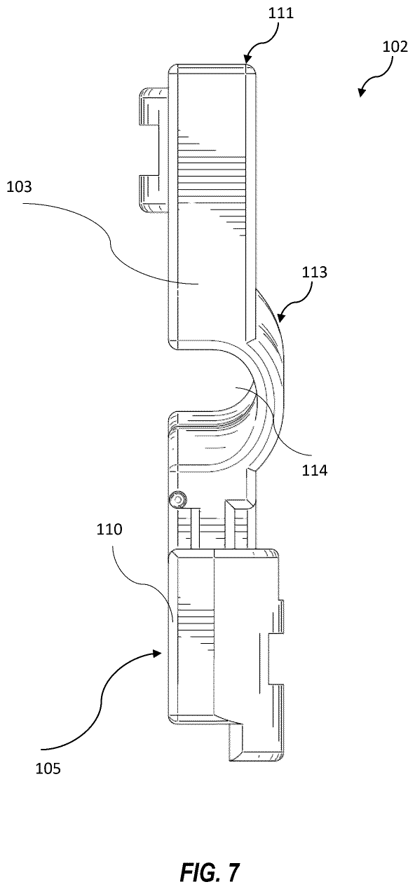

Referring now additionally to FIGS. 4-5, another embodiment of the irrigation device 200 is now described. In this embodiment of the irrigation device 200, those elements already discussed above with respect to FIGS. 1-3 are incremented by 100 and most require no further discussion herein. This embodiment differs from the previous embodiment in that this irrigation device 200 illustratively includes a water hose 215 having a proximal end 216 extending through the U-shaped channel of the lower lateral arm 210, the lateral slot 214, and then the upper lateral arm 212. The irrigation device 200 also includes and a spray device 220 coupled to the distal end 217 of the water hose 215 above the upper lateral arm 212. In other words, this irrigation device 200 projects the water spray upward.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. An irrigation device to be attached to a pot, the irrigation device comprising:
an irrigation body comprising
a first side and a second side opposite the first side,
a lower end between the first and second sides and comprising first and second vertical arms defining a slot therebetween to receive a wall of the pot, the lower end comprising a lower lateral arm adjacent to the first side,
an upper end above the lower end and between the first and second sides, the upper end comprising an upper lateral arm adjacent to the second side,
a medial portion between the first and second sides and between the lower end and the upper end, the medial portion defining a lateral slot extending from the first side to the second side;
a water hose having a proximal end extending through the lower lateral arm and a distal end extending through the upper lateral arm; and
a spray device coupled to the distal end of the water hose adjacent to the upper lateral arm.
